(19) United States
(12) Patent Application Publication
(10) Pub. No.: US 2026/0266658 A1
(43) Pub. Date: Sep. 10, 2026

(54) METHODS AND APPARATUS FOR IMPLEMENTING SINGLE CAPACITOR CONSTANT GAIN DIFFERENCE AMPLIFIER AND SEMI AUTONOMOUS SELF-RESET EVENT PIXEL

(71) Applicants: Hussein Ali, Foothill Ranch, CA (US); Mehdi Habibi, Lantana, TX (US); Rajkumar Chinnakonda Kubendran, Pittsburgh, PA (US)

(72) Inventors: Hussein Ali, Foothill Ranch, CA (US); Mehdi Habibi, Lantana, TX (US); Rajkumar Chinnakonda Kubendran, Pittsburgh, PA (US)

(21) Appl. No.: 19/440,546

(22) Filed: Jan. 5, 2026

Related U.S. Application Data
(60) Provisional application No. 63/769,710, filed on Mar. 10, 2025.

(51) Int. Cl. G01J 1/44

(52) U.S. Cl. CPC G01J 1/44; G01J 2001/446

(57) ABSTRACT

Event based sensors generate output only when a significant change in pixel intensity occurs, unlike frame-based imagers that produce a constant stream of data. This technique offers benefits like improved high-speed visual acquisition, low power consumption, and higher dynamic range performance. The proposed circuit achieves lower capacitance, reduced power consumption, and better suppression of voltage drifts and noise sources compared to conventional methods.

### RELATED APPLICATIONS

This application claims the priority of U.S. Provisional Application No. 63/769,710, entitled “SINGLE CAPACITOR CONSTANT GAIN LOGARTIMIC DIFFERENCE AMPLIFIER AND SYNCHRONOUS SELF-RESET PIXEL FOR EVENT BASED INTENSITY CHANGE DETECTION SENSORS” filed on Mar. 10, 2025, the disclosure of which is hereby incorporated by reference in its entirety.

### BACKGROUND OF THE INVENTION

Like frame-based imagers, event-based cameras can collect information from the visual information of the scene, however, unlike their frame-based counterparts, they do not produce a constant stream of data which represent output bitmaps of visual information but rather generate output whenever a significant change in a pixel intensity occurs. Whenever this happens a so-called event will be generated for that specific event. The data that is generated for every event is the location of the event and the time it has occurred. This method of representing visual information can benefit from improved high-speed visual acquiring, low power consumption and higher dynamic range performance factors.

In all image sensors each pixel has an interfacing circuit connected to the light sensitive electronic element, in most cases a photodiode. The data generated by the interfacing circuit, either analog or digital, should be readout using an access circuit. In event driven sensors, the interfacing circuit converts the photocurrent into a digital trigger signal, telling the readout circuit that a significant visual change has occurred in the pixel. Many different interfacing circuits have been proposed to enhance the performance of the event-based pixel and increase its accuracy and increase its robustness to unwanted effects such as process variations.

At the very first stage of an event-based interface circuit, a logarithmic response circuit is used to enhance the dynamic range, making the sensor operatable at both very high and very low illumination levels. In the next step a temporal contrast change detection circuit is used to detect changes that surpass a certain threshold limit. Usually in this step a capacitive switch capacitor amplifier is initially used to both sample the signal and use it as a reference for future difference detection and to amplify the generated difference signal. This will often involve the use of two capacitors, one in the sampling path of the amplifier and another capacitor in the feedback loop of the amplifier. The ratio of the two capacitors defines the gain of the amplifier. The gain of the stage is determined by the value of the sampling capacitor, Cₛ, and the feedback capacitance, C_{f}. To decrease the effect of noise and mismatches in the second stages a gain of more than 10 is usually used in conventional circuits. This translates to a capacitor ratio of Cₛ/C_{f}>10. If the minimum size capacitor available in a technology where mismatch effects are negligible is considered Cₘᵢₙ then Cₛ>10Cₘᵢₙ. This lower limit on Cₛ affects the lower power usage limit and pixel size.

In the next step of the temporal change detection, a comparator is used to compare the amplified difference signal with a specific threshold. The resulting circuit continuously monitors the photocurrent and generates events only when a significant intensity change is detected. Accurate threshold levels are essential in event-based sensors, as they directly impact the quality and quantity of generated events. A well-designed circuit ensures that events are triggered only by specific and predefined intensity changes, minimizing noise and maximizing sensitivity.

### SUMMARY OF THE INVENTION

Conventional event detection pixels usually use a two-capacitor switch capacitor amplifier to both sample and amplify the difference of the logarithmic photodiode current signal. The gain of the amplifier is usually adjusted using the ratio of two capacitors and the constant gain of the amplifier is important to achieve robust performance. In this patent disclosure a method is proposed to be used in conjunction with a logarithmic photo-circuit Transimpedance Amplifier (“TIA”) to produce a constant gain without using two capacitors. Only a single capacitor is used to sample the photodiode output signal. The use of a single capacitor will significantly reduce power consumption due to lower bias current requirements and reduce the pixel area and size allowing the potential to reach high pixel resolution much easier. Furthermore, an approach is disclosed for implementing comparators which while mitigate drift effects, allow wide threshold adjustment range as well. In the proposed patent a semi-autonomous self-resetting pixel is also disclosed in which the event-based pixel is reset using in-pixel hardware as soon as an event is detected, but the reset condition is removed by the out-of-pixel hardware after the event state is acquired.

The proposed system and methods include embodiments comprising a one capacitor circuit which can be used to detect specific changes in the photodiode logarithmic response. In one embodiment, a logarithmic change detection pixel comprising of the following blocks in the signal chain: 1) Photodiode+TIA 2) Filter/Buffer circuit 3) Open loop, gain stabilized, difference amplifier 4) Comparators and 5) Digital logic circuit; in which the said chain up to the comparators can produce a constant gain without the use of a feedback capacitor. Unlike conventional techniques, which use a feedback capacitor amplifier in the signal path, here, a different type of difference amplifier is used in the signal chain which in combination with the preceding logarithmic stage provides unique properties in the pixel. Advantageously, the signal chain with an open loop difference amplifier in the middle overcomes the drawbacks in the prior art.

In one embodiment, a Common-Source derived stage with active load and no feedback capacitor may be placed after a sampling capacitor in the logarithmic change detection pixel. Adjusting the active load current of the said Common-Source derived stage such that the MOSFET devices enter the subthreshold region and thus in conjunction with the gain of the first logarithmic stage produces an overall gain independent of the capacitors, bias current and temperature.

According to one embodiment, the said Common-Source stage is initially placed in a unity gain feedback loop with no feedback capacitors. In the unity gain feedback, an initial sample is stored on the sample capacitor. The change on the photocurrent is then amplified with a constant gain of (2λ)⁻¹/(percent current change) and fed to the comparators.

All other variants of the proposed circuit including cascade structures, differential pairs, complementary devices such as those shown in FIG. 2, and additional buffer circuits in the signal path which eventually develop a similar gain independent of the capacitors and process, are all derived from the same basic principle and part of the disclosed invention.

In the presented pixel, the difference-amplifier connects to comparators which are comprised of source controlled common-source stages. The common-source stages guarantee that the general structure of the comparators is similar to the amplifier so that the operation point drifts due to temperature and process of the comparators are correlated with the amplifier operating point. Additionally, using source biasing, a wider threshold range can be covered compared with prior art. Common drain stages can be used to drive the source of the common-source comparator.

A semi-autonomous self-reset pixel architecture is also presented where the pixel resets autonomously, but the reset state is removed using out-of-pixel hardware. While requiring a low number of digital blocks, this approach lowers the latency and at the same time enhances the settling time of the pixel. The configuration can be used in both synchronous pixel event access and in-pixel processing hardware.

The pixel architecture may include a pixel circuit comprising a photodiode receiving a photon signal and converting the photon signal into a photocurrent. The pixel architecture may further include a logarithmic transimpedance amplifier in communication with the photodiode and converting the photocurrent into a logarithmic voltage. In one embodiment, an open loop gain stabilized difference amplifier may amplify the logarithmic voltage from the transimpedance amplifier to generate an amplified voltage. A dual comparator stage may determine if the amplified voltage meets a positive threshold and a negative threshold. In one embodiment, the dual comparator stage may produce a dual comparator output signal. The pixel architecture may also include a digital logic stage producing a constant gain from the dual comparator output.

In one embodiment, the open loop gain stabilized difference amplifier may be located between the logarithmic transimpedance amplifier and the dual comparator stage. The open loop gain stabilized difference amplifier may include a plurality of transistors operating in a subthreshold region. Furthermore, the open loop gain stabilized difference amplifier may include an output node and the above noted plurality of transistors may be composed of a top transistor and a bottom transistor. The plurality of transistors may be advantageously cascaded. The pixel circuit may also include filter and buffer stage removing noise from the logarithmic voltage and stabilizing the logarithmic voltage to create a conditioned logarithmic voltage. A sampling stage may receive the conditioned logarithmic voltage prior to transmission to the open loop gain stabilized difference amplifier. In one embodiment, a digital output and reset logic stage may receive the dual comparator output signal and generate a digital downstream signal and a reset signal.

The pixel architecture, according to some embodiments may include a photodiode receiving a photon signal and converting the photon signal into a photocurrent. A logarithmic transimpedance amplifier may be in communication with the photodiode and converting the photocurrent into a logarithmic voltage. The pixel circuit may advantageously include a closed loop gain stabilized difference amplifier amplifying the logarithmic voltage from the transimpedance amplifier to generate an amplified voltage. In one embodiment, a dual comparator stage may determine if the amplified voltage meets a positive threshold and a negative threshold. The dual comparator stage may be further configured to generate a dual comparator output signal. A digital logic stage may further produce a constant gain from the dual comparator output. In one embodiment, the closed loop gain stabilized difference amplifier is located between the logarithmic transimpedance amplifier and the dual comparator stage. The logic stage may be configured to register a generated event signal based on the dual comparator output signal. The pixel circuit may further include a storage flip flop latching the generated event signal and an in-pixel processing circuit configured to provide for semi-autonomous self-reset when an event is detected.

The in-pixel processing circuit may be configured to receive the generated event signal and the in-pixel processing circuit is in communication with a plurality of neighbor cells. In one embodiment, an external processor (external to the pixel circuite) may be configured to access and synchronously readout the generated event signal. The pixel circuit may include an array of pixels interconnected to the plurality of neighbor cells. The array of pixels may, for example, synchronously generate a scan complete signal wherein the scan complete signal informs a pixel reset state. The pixel circuit may also include access circuitry including a bit select transistor, a row select line and a synchronous column line, the access circuitry providing the external processor access to the generated event signal. In one embodiment, the logarithmic transimpedance amplifier includes an open loop configuration. Still yet, other implementations may take advantage of a logarithmic transimpedance amplifier implemented in a stacked closed loop configuration.

### BRIEF DESCRIPTION OF THE FIGURES

FIG. 1 illustrates a block diagram of a single sampling capacitor logarithmic change detection pixel.

FIG. 2A illustrates a complementary-type common source gain stabilized amplifier for the logarithmic change detection pixel.

FIG. 2B illustrates a cascade type common source gain stabilized amplifier for the logarithmic change detection pixel.

FIG. 3 illustrates a semi-autonomous self-resetting event-based pixel together with the common drain source biased comparator.

FIG. 4 illustrates circuit diagrams for transimpedance amplifiers, comparators and access circuitry.

FIG. 5 illustrates a schematic diagram of a vision sensor system according to one embodiment.

### DETAILED DESCRIPTION OF THE INVENTION

The present invention is described in the following examples, which are set forth to aid in the understanding of the invention and should not be construed to limit in any way the scope of the invention as defined in the claims which follow thereafter.

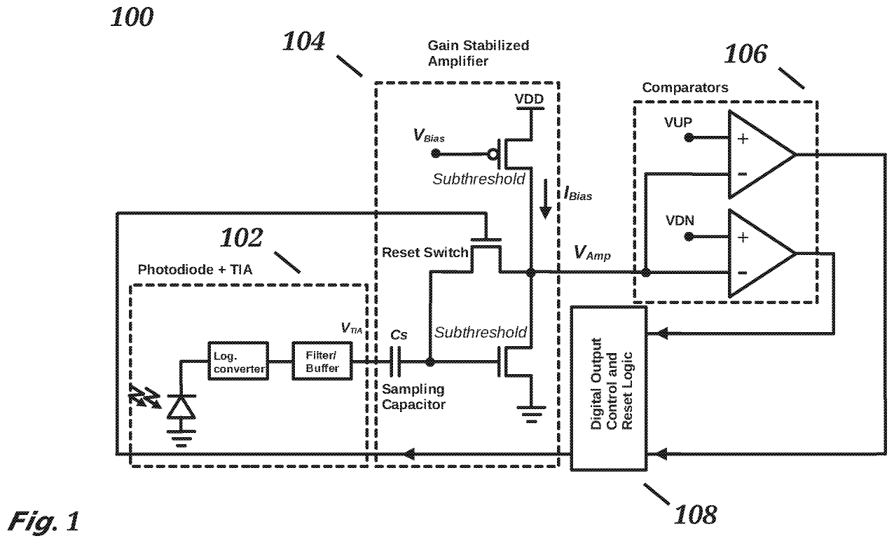

FIG. 1 illustrates a block diagram 100 of a single sampling capacitor logarithmic change detection pixel. The circuit includes a photodiode and TIA stage 102, a common source derived gain stabilized difference amplifier 104, a pair of comparators 106 and a digital output control and reset logic block 108.

The photodiode and TIA 102 detect incoming light (photons) and converts it into a current proportional to the light intensity. The photodiode produces a small current signal that represents the brightness level of the detected light. The Logarithmic Converter function of the TIA converts the photodiode's current output into a logarithmic voltage signal (ΔV_{TIA}). This compresses a wide range of light intensities into a smaller voltage range, which can be informative for high dynamic range (HDR) sensing. The Filter/Buffer removes noise and stabilizes the signal. The filtering and buffering offer stable voltage proportional to the log of the light intensity.

Within the common source derived gain stabilized difference amplifier 104, FIG. 1 illustrates sampling capacitor Cₛ and Reset Switch. The sampling capacitor may hold the analog voltage signal temporarily. The reset switch resets or clears the stored charge before a new measurement. The sampling capacitor effectively prepares the signal for differential amplification and conversion. The common source derived gain stabilized difference amplifier 104 may utilize MOS transistors operating in the subthreshold region instead of an operational amplifier with feedback capacitors (shown in FIG. 1). In one embodiment, the transistors may be biased by supply voltage (VDD), bias voltage (Vbias) for controlling transistor operation in the subthreshold region and reference bias current (Ibias) defining the gain of the amplifier. With this configuration and sub-threshold operations, the common source derived amplifier 104 provides gain with low power consumption. The biasing ensures gain stabilization, making the amplifier's gain less sensitive to temperature or transistor variation. The output from the common source derived amplifier 104 is labeled ΔVamp and represents the amplified difference signal. Comparators 106 compare the amplified signal (ΔVamp) against two reference levels—VUP (upper threshold voltage) and VDN (lower threshold voltage). The output of the comparators includes logic signals indicating whether ΔVamp is above VUP or below VDN. These signals are sent to the Digital Output Control and Reset Logic 108. The Digital Output Control and Reset Logic receive the input signal from the comparators and generates a digital output representing the sensor's state or brightness level. The reset signal may control the sampling/reset switch. The Digital Output Control and Reset Logic may convert analog information into a digital signal that can be read or processed by downstream electronics (e.g., an ADC or digital logic).

To summarize, the photodiode converts light into current which is fed into the 102 TIA log converter and filter/buffer to condition this signal into a voltage ΔV_{TIA}. The sampling stage stores this voltage and feeds it to the difference amplifier 104, producing ΔVamp. The comparators 106 check whether ΔVamp crosses the upper or lower limits (VUP, VDN) and send a signal to the digital output logic. The digital output logic 108 produces a digital signal accordingly and resets the circuit for the next measurement.

The single capacitor difference amplifier 104 proposed here decreases the capacitor size in the pixel design of imagers both in terms of the number of capacitors and the value of the capacitor.

As shown in FIG. 1, in the proposed circuit design 104 a single Cₛ=Cₘᵢₙ capacitor is used. Cₘᵢₙ functions as the sampling capacitor. The constant gain functionality is achieved by using a common source stage with active load (other permeative and derivatives such as complementary, cascade, differential pairs can gain similar results). The active load current is adjusted to place the common source stage in the subthreshold region. In the proposed configuration, the transfer function of the subthreshold gain stage together with the transfer function of the previous logarithmic stage will provide a constant gain property. With high enough channel lengths, the obtained gain will be relatively independent of voltage, process and temperature.

Several important achievements are thus obtained with the circuit proposed in FIG. 1 compared with the conventional approach. The total capacitance required in the proposed method is much lower than the conventional method thus a lower pixel area will be used for the analog circuit. With a lower capacitance value, lower bias currents and thus lower power consumption is required per pixel. Since the amount of gain is much higher compared with previous switch-capacitor counterparts, the voltage drifts and noise sources are suppressed much better when referred to the input. Another important achievement is the obtained gain is independent of many factors compared with the conventional approach.

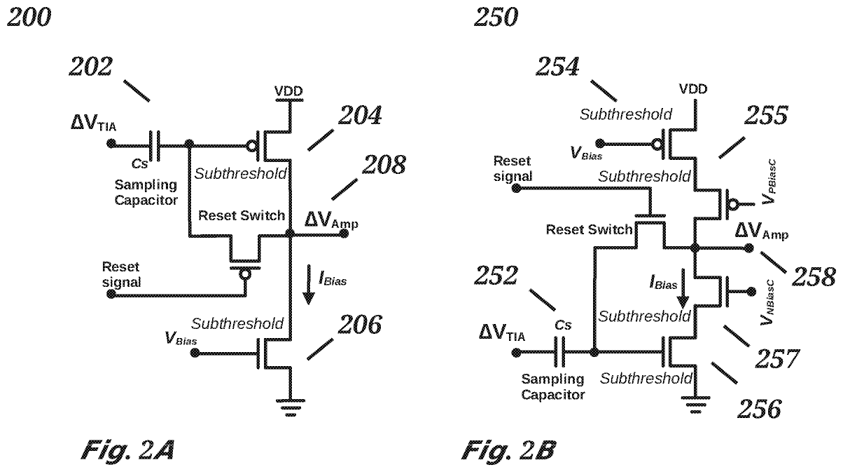

Different derivates of the common source stage with active load can be used as the difference amplifier given that the common source stage and the active load are biased in the subthreshold region. FIGS. 2A and 2B. illustrates some possible derivatives of the common source gain stabilized difference amplifier.

FIG. 2A illustrates a complementary-type common source gain stabilized amplifier 200 for the logarithmic change detection pixel. As shown in FIG. 2A, the gain stabilized difference amplifier includes a sampling capacitor 202, a top transistor operating in the a subthreshold region 204, a bottom transistor operating in the subthreshold region 206, and an output node 208. The sampling capacitor stores the analog voltage corresponding to the logarithmic light signal and retains the input signal for processing transient light variations into a stable voltage for amplification. The top transistor 204 operates in the subthreshold region (ensuring low power consumption and provides an exponential current-voltage relationship, allowing a high gain even at low bias currents. The top transistor 204 converts the input voltage variation on its gate into a current variation, producing the output voltage (ΔVₐₘₚ) at the output node 208. The bottom transistor 206 operates with bias voltage V_{bias} and sets the bias current I_{Bias}. The output node 208 produces the amplified signal corresponding to the stored input signal ΔV_{TIA} and the reference or reset level.

FIG. 2B illustrates a cascade type common source gain stabilized amplifier 250 for the logarithmic change detection pixel. As shown in FIG. 2B, the gain stabilized difference amplifier includes a sampling capacitor 252, a top transistor operating in the subthreshold region 254, a bottom transistor operating in the subthreshold region 256, and an output node 258. Transistors 255 and 257 are the cascade devices. The sampling capacitor stores the analog voltage corresponding to the logarithmic light signal and retains the input signal for processing transient light variations into a stable voltage for amplification. With the cascade structure higher gains can be obtained in the amplifier by increasing the output impedance and using the cascade the effective gain can be squared. The desired contrast threshold range usually dictates the gain order required in the amplifier.

The value of the sampling capacitor is important in the pixel design since it affects both the area of the pixel and power consumption. For a given response time of the pixel, τₚᵢₓₑₗ, the static power usage increases with higher sampling capacitor size. Considering n as the subthreshold constant, V_{T} as the thermal voltage and g_{m_buff} the transconductance of the preceding stage buffer, Equation 1 shows the required buffer stage minimum bias current, I_{bias_buff_min}, to support the required response time.

$${τ}_{pixel} = {C}_{s} \cdot {g}_{m \_ buff}^{- 1} = \frac{{C}_{s} \cdot n \cdot {V}_{T}}{{I}_{bias \_ buff}} \to {I}_{bias \_ buff \_min} = \frac{{C}_{min} \cdot n \cdot {V}_{T}}{{τ}_{pixel}} \qquad ( 1 )$$

Since in the conventional approach Cₛ=10Cₘᵢₙ, for the same amount of response time a much higher bias current and hence power dissipation would be required. But with the proposed method since a lower capacitance value can be chosen for the sampling capacitor, a lower power dissipation will be observed.

To guarantee subthreshold operation, the bias current, I_{Bias}, should be adjusted below the subthreshold saturation limit, I_{sub_sat} (I_{BIAS}<I_{sub_sat}). This current limit can be obtained according to equation 2 by considering the current at which the transconductance of the subthreshold region, g_{m_sub}, is equal to the transconductance of the saturation region, g_{m_sat} as follows:

$${g}_{{m}_{sat}} = {g}_{{m}_{sub}} \to \sqrt{2 μ \cdot {c}_{ox} \cdot \frac{W}{L} \cdot {I}_{sub \_ sat}} = \frac{{I}_{sub \_ sat}}{{nV}_{T}} \to {I}_{sub \_ sat} = {( {nV}_{T} )}^{2} \cdot 2 μ \cdot {c}_{ox} \cdot \frac{W}{L} \approx 1 μ A \cdot \frac{W}{L} \qquad ( 2 )$$

where μ is the mobility, W and L are the common source stage MOSFET dimensions and cₒₓ is the unit area capacitance.

To increase the accuracy and stability of the threshold detection against process variations, the fixed gain amplifier right after the logarithmic circuit has an important role. Considering rₒ as the MOSFET output resistance, λ as the channel length modulation factor (DIBL effects can also be modelled with the same approach), g_{m_log} the transconductance of the photodiode MOSFET load in the logarithmic stage, Iₚₕₒₜₒ the baseline photocurrent and DT the photocurrent percent change, ΔV_{TIA} the output voltage change of the TIA, ΔV_{Amp} the output voltage change of the amplifier, the gain of the proposed method, A_{proposed} can be obtained using equations 3, 4 and 5

$$Δ {V}_{TIA} = \frac{Δ {I}_{photo}}{{g}_{m \_ log}} = Δ {I}_{photo} \cdot \frac{n \cdot {V}_{T}}{{I}_{photo}} = n \cdot {V}_{T} \cdot \frac{Δ {I}_{photo}}{{I}_{photo}} = n \cdot {V}_{T} \cdot DT \qquad ( 3 )$$

$$Δ {V}_{Amp \_ proposed} = Δ {V}_{TIA} \cdot {g}_{{m}_{amp}} \cdot ( {r}_{{o}_{n}} ‖ {r}_{{o}_{p}} ) = n \cdot {V}_{T} \cdot DT \cdot \frac{{I}_{bias \_ amp}}{n \cdot {V}_{T}} \cdot \frac{1}{2 λ {I}_{bias \_ amp}} = \frac{DT}{2 λ} \qquad ( 4 )$$

$${A}_{proposed} = \frac{Δ {V}_{Amp \_ proposed}}{DT} = \frac{1}{2 λ} \qquad ( 5 )$$

As can be seen, the gain even has relatively high stability to bias current variations as well. The gain of prior art, A_{conv}, can be obtained as shown in 6 and 7.

$$Δ {V}_{Amp \_ conv} = n \cdot {V}_{T} \cdot DT \cdot \frac{{C}_{s}}{{C}_{f}} \qquad ( 6 )$$

$${A}_{conv} = \frac{Δ {V}_{Amp \_ conv}}{DT} \qquad ( 7 )$$

Comparing the gain of the proposed method to what exists in prior art, a much higher value is obtained in the proposed circuit which can enhance the circuit's performance.

If DTₑᵥₑₙₜ₊ and DTₑᵥₑₙₜ₋ are considered as the percentage photocurrent change for positive and negative events, as equations 8 and 9 show, with a higher gain of A, the effect of mismatches and variations, ΔVₓ, will be attenuated better when referred to the input to obtain the change detection threshold.

$${DT}_{event +} = \frac{VUP - Vref}{A} + \frac{Δ {V}_{x}}{A} \qquad ( 8 )$$

$${DT}_{event -} = \frac{Vref - VDN}{A} + \frac{Δ {V}_{x}}{A} \qquad ( 9 )$$

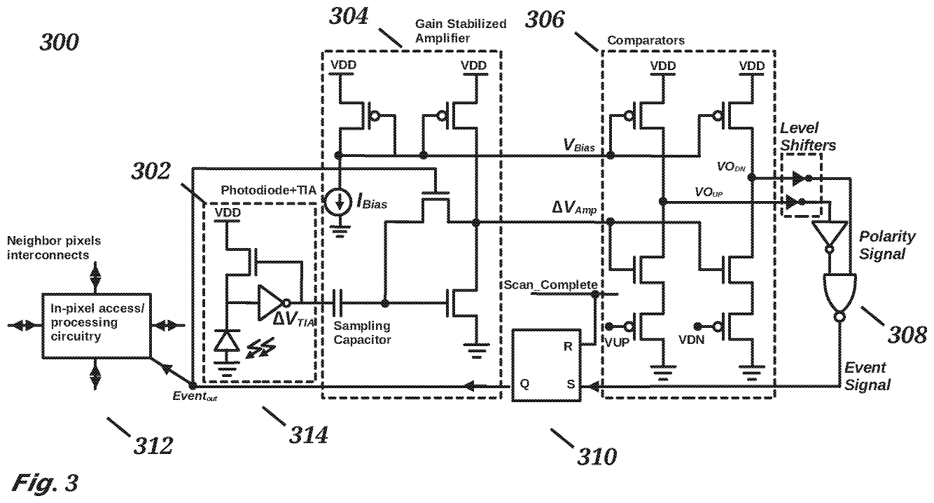

FIG. 3 illustrates a possible configuration for the disclosed pixel 300. FIG. 3 includes a closed loop logarithmic TIA stage 302, the disclosed difference amplifier 304, a pair of 3 transistor comparators 306, and the logic 308 which registers the generated event and sets the storage flip flop 310 and the in-pixel access/processing circuitry 312. In the closed loop TIA 302, the load MOSFET on top of the photodiode logarithmically converts the photocurrent into a voltage signal while the feedback amplifier helps increase the bandwidth of the TIA.

The gain stabilized amplifier amplifies 304 the weak signal and ensures consistent amplification regardless of variations in temperature or transistor behavior. Each 306 comparator is comprised of a combination of a common source (the nMOS and the upper pMOS) and common drain (the lower pMOS and the upper pMOS) amplifier. The upper pMOS acts as the load bias current for both the common source and common drain amplifiers. Whenever the gate voltage of the common source exceeds the voltage on the source of the nMOS plus the overdrive voltage, the output of the amplifier will be driven low and a change is initiated. The voltage to the common source is generated through the common drain stage. With high enough gain, this amplifier combination will function as a comparator.

In the disclosed comparator approach, while the maximum current of the comparator branch is controlled by the load pMOS current source and not dependent on the VUP and VDN threshold controlling voltages, still a good matching exists with the previous amplifier stage and thus the drifts of both stages can be cancelled out. After the comparators compare the signal against reference voltages VUP (Upper Threshold) and VDN (Lower Threshold), using the disclosed logic 308, if either the comparator connected to VUP generates a high or the comparator connected to VDN generates a low an event is detected and the RS flipflop is latched on a set state. The state is maintained until the scan_complete signal is asserted using out-of-pixel hardware The generated event signal 314 is connected to the in-pixel access/processing circuitry 312. Both access circuitry and processing have access to neighbor cells using either bus lines or local interconnects. These connections help the pixel communicate with the neighbors for data processing or to transfer the data to the output.

As illustrated in FIG. 3, the event states can be either accessed and read out synchronously by an external processor or used for asynchronous in-pixel processing. In both cases the scan_complete signal is generated synchronously among a group of pixels such as the entire array or row by row. Whenever an event is detected inside the pixel, using the in-pixel circuitry, the pixel is autonomously reset internally so that the pixel has enough time to reach steady state conditions. Whenever the generated events are read out by the acquiring processor or accessed through the in-pixel processing hardware, the pixel reset state is removed with the scan_complete signal synchronously. So, although the resetting is asynchronous but the removal of the pixel from the reset state is performed synchronously and thus the method is semi-autonomous.

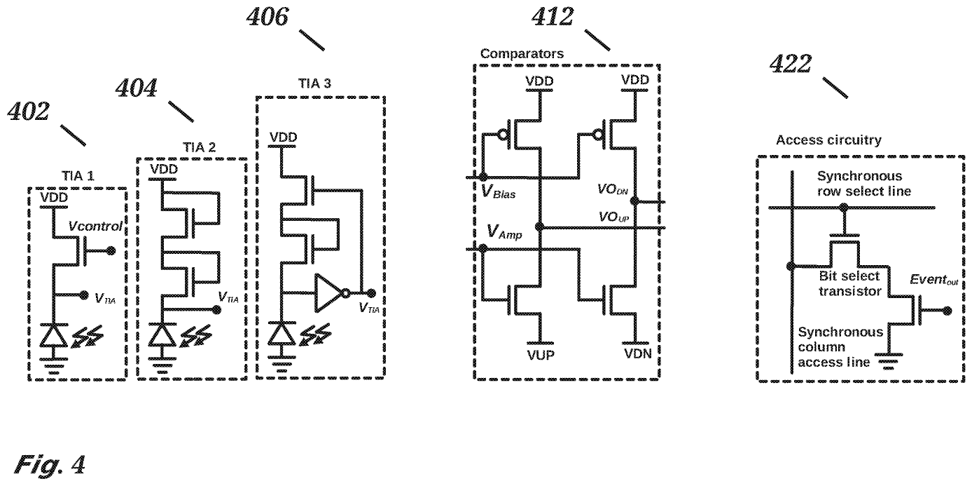

Similar to the difference amplifiers which can be implemented with several options, other circuit and hardware variants can be used for the TIA, comparators and the access/processing block. FIG. 4 shows some of these variants. For the TIA section 102, the open loop configuration 402 can switch between integration mode and logarithmic mode but suffers from a lower bandwidth compared to the closed loop 302. The stacked open loop TIA 404 and stacked closed loop TIA 406 benefit from a higher TIA gain and thus can be used to detect lower contrast levels but the latency is higher than the non-stacked versions. The comparator variant 412 directly applies the source bias voltage to the common source stage and by omitting the common drain stage a better matching is obtained with the amplifier however current will be drawn from the bias lines which will require a dedicated driver for supplying the bias voltages. In the access circuitry 422, the readout of the registered and latched events by an external processor can be accomplished with the bit select transistor, row-select line and synchronous column access line.

The disclosed pixel can be stacked onto a diverse range of next layer access/processing hardware. Such stacks could include hardware that can access the events in a function of a group of pixels, hardware that can concatenate clusters of events into a single bit (as described in next patent!). For the in-pixel processor category kernel convolution blocks, data compressors, neural network chains can be stacked on top of the proposed pixel.

Since the presented pixel reduces power consumption, it is a suitable choice for event imagers which are used in portable and energy constraint applications such as self-powered surveillance units, drones and satellites. Also, due to the lower heat generation and thus simpler cooling the pixel is also a suitable choice for designing images which are to be used to quantum computers that rely on photon emission.

As can be understood from above, Event-based vision systems depart fundamentally from conventional frame-based imaging by operating asynchronously and reporting only local changes in scene illumination. Instead of capturing full image frames at fixed time intervals, each pixel independently detects temporal contrast and emits an event when the change in intensity exceeds a defined threshold. Each event encodes pixel location, polarity, and precise timing, enabling continuous-time visual sensing with microsecond-level temporal resolution, extremely low latency, and reduced data redundancy.

This sensing paradigm is particularly advantageous in dynamic environments. Because information is generated only when change occurs, event-based sensors naturally suppress static background content and focus computational resources on relevant motion. The result is a significant reduction in bandwidth and power consumption compared to frame-based systems, while simultaneously increasing responsiveness and robustness to motion blur. The asynchronous nature of the output allows accurate perception under rapid motion, high dynamic range scenes, and low-light conditions where exposure-based imaging is limited.

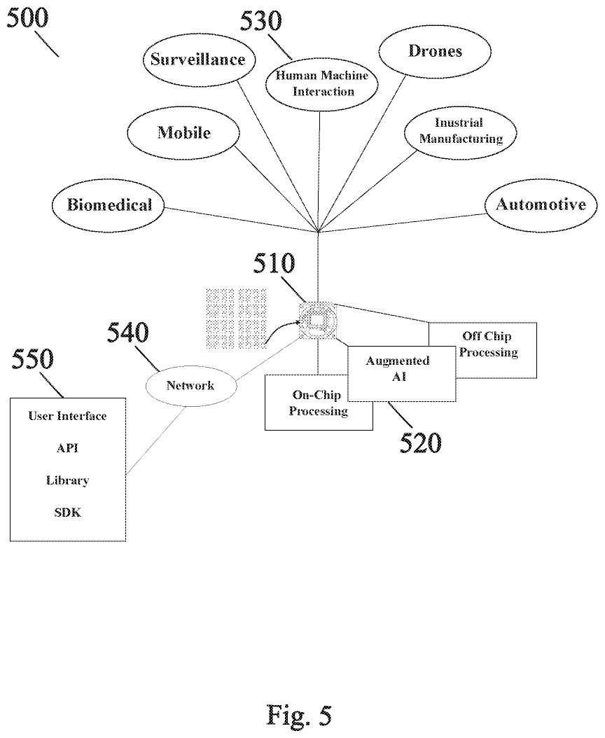

FIG. 5 illustrates a schematic diagram of a vision sensor system according to one embodiment. The vision sensor system 500 depicted in FIG. 5 includes a sensor/array of sensors 510, a suite of processing blocks 520, including on-chip processing, augmented AI and off chip processing. The schematic further includes a network 540 in communication with the sensor/array of sensors and a software stack 550. The software 550 may include a graphical user interface, an Application Programming Interface (API), a software library, and a software development kit (SDK). The software may include modules customized to operate in a set of environment specific applications 530. In one example, the et of environment specific applications may include biomedical, mobile, human machine interaction, industrial/manufacturing, drones and surveillance, among others.

In mobile and embedded imaging applications, event-based vision enables motion-aware reconstruction and stabilization. Continuous temporal sampling allows fine-grained estimation of motion vectors, which can be used to correct blur, track fast-moving features, or reconstruct intensity images with improved sharpness. These capabilities are especially valuable when either the sensor or the observed scene is in motion.

For human-machine interaction, event-driven sensing supports high-precision tracking of eye movements, gestures, and fine motor actions. Because temporal resolution is not constrained by a global frame rate, rapid micro-movements can be detected with minimal latency. This enables responsive interaction in immersive systems and allows detection of high-frequency visual phenomena such as flicker or subtle motion cues across a wide range of illumination levels.

In surveillance contexts, event-based vision enables detection of critical motion patterns—such as falls, intrusions, or abnormal activity—while inherently limiting the capture of identifiable visual detail. Since the sensor reports changes rather than full images, privacy-preserving observation is possible without sacrificing temporal fidelity or responsiveness. Similar advantages apply to crowd analysis, traffic monitoring, and visual odometry, where continuous motion estimation benefits from precise event timing and sparse data representation.

Industrial and manufacturing applications benefit from the ability of event-based sensors to observe motion over an extremely wide temporal bandwidth. The effective temporal resolution corresponds to frame rates on the order of hundreds of thousands to millions of frames per second, enabling analysis of vibrations, oscillations, and transient phenomena that are inaccessible to conventional cameras. This makes the technology well suited for high-speed object counting, particle tracking, conveyor monitoring, and predictive maintenance through vibration analysis.

In drones and robotic systems, event-based vision supports accurate tracking of edges, markers, and structural features in three dimensions. The high temporal precision improves pose estimation and motion prediction, which are critical for closed-loop control in manipulation, navigation, and pick-and-place automation. Continuous event streams allow robots to react to changes in real time rather than waiting for the next image frame.

For automotive and mobility systems, event-driven perception enhances object detection and tracking in challenging conditions, including high relative speeds, rapid lighting transitions, and scenes with extreme contrast. The sensors described herein also lend their advantages to autonomous driving tasks. Event-based sensing also supports real-time monitoring of driver behavior by detecting fine eye and facial movements, enabling rapid assessment of attention and alertness.

In biomedical and scientific applications, the ability to detect microscopic or subtle motion at high temporal resolution enables accelerated analysis of biological processes. Event-based sensors can identify motion signatures that occur on very short time scales, significantly reducing the duration of procedures that rely on visual observation of dynamic samples.

Across these application domains, the unifying technical advantage of event-based vision lies in its asynchronous, data-efficient representation of visual information. By encoding only meaningful temporal changes with precise timing, event-based systems provide high-speed, low-latency perception while minimizing power, bandwidth, and computational overhead compared to traditional frame-based imaging architectures.

While the foregoing invention has been described in some detail for purposes of clarity and understanding, it will be appreciated by one skilled in the art, from a reading of the disclosure, that various changes in form and detail can be made without departing from the true scope of the invention.

1. A pixel circuit, comprising:
a photodiode receiving a photon signal and converting the photon signal into a photocurrent;
a logarithmic transimpedance amplifier in communication with the photodiode and converting the photocurrent into a logarithmic voltage;
an open loop gain stabilized difference amplifier amplifying the logarithmic voltage from the transimpedance amplifier to generate an amplified voltage;
a dual comparator stage determining if the amplified voltage meets a positive threshold and a negative threshold, the dual comparator stage producing a dual comparator output signal;
a digital logic stage producing a constant gain from the dual comparator output.

2. The pixel circuit of claim 1, wherein the open loop gain stabilized difference amplifier is located between the logarithmic transimpedance amplifier and the dual comparator stage.

3. The pixel circuit of claim 1, wherein the open loop gain stabilized difference amplifier includes a plurality of transistors operating in a subthreshold region.

4. The pixel circuit of claim 3, wherein the open loop gain stabilized difference amplifier includes an output node and wherein the plurality of transistors includes a top transistor and a bottom transistor.

5. The pixel circuit of claim 4, wherein the plurality of transistors are cascaded.

6. The pixel circuit of claim 1, further comprising a filter and buffer stage removing noise from the logarithmic voltage and stabilizing the logarithmic voltage to create a conditioned logarithmic voltage.

7. The pixel circuit of claim 6, further comprising a sampling stage receiving the conditioned logarithmic voltage prior to transmission to the open loop gain stabilized difference amplifier.

8. The pixel circuit of claim 1, further comprising a digital output and reset logic stage receiving the dual comparator output signal, the digital output and reset logic stage generating a digital downstream signal and a reset signal.

9. A pixel circuit, comprising:
a photodiode receiving a photon signal and converting the photon signal into a photocurrent;
a logarithmic transimpedance amplifier in communication with the photodiode and converting the photocurrent into a logarithmic voltage;
a closed loop gain stabilized difference amplifier amplifying the logarithmic voltage from the transimpedance amplifier to generate an amplified voltage;
a dual comparator stage determining if the amplified voltage meets a positive threshold and a negative threshold, the dual comparator stage producing a dual comparator output signal;
a digital logic stage producing a constant gain from the dual comparator output.

10. The pixel circuit of claim 9, wherein the closed loop gain stabilized difference amplifier is located between the logarithmic transimpedance amplifier and the dual comparator stage.

11. The pixel circuit of claim 9, further comprising:
a logic stage registering a generated event signal based on the dual comparator output signal.

12. The pixel circuit of claim 11, further comprising:
a storage flip flop latching the generated event signal.

13. The pixel circuit of claim 12, further comprising an in-pixel processing circuit configured to provide for semi-autonomous self-reset when an event is detected.

14. The pixel circuit of claim 13, wherein the in-pixel processing circuit is configured to receive the generated event signal and the in-pixel processing circuit is in communication with a plurality of neighbor cells.

15. The pixel circuit of claim 14, further comprising:
an external processor configured to access and synchronously readout the generated event signal, wherein the external processor is external to the pixel circuit.

16. The pixel circuit of claim 15, further comprising:
an array of pixels interconnected to the plurality of neighbor cells.

17. The pixel circuit of claim 15, further comprising:
the array of pixels synchronously generating a scan complete signal, the scan complete signal informing a pixel reset state.

18. The pixel circuit of claim 16, further comprising:
access circuitry including a bit select transistor, a row select line and a synchronous column line, the access circuitry providing the external processor access to the generated event signal.

19. The pixel circuit of claim 9, wherein the logarithmic transimpedance amplifier includes an open loop configuration.

20. The pixel circuit of claim 9, wherein the logarithmic transimpedance amplifier includes a stacked closed loop configuration.
